(19) United States
(12) Patent Application Publication
(10) Pub. No.: US 2023/0144496 A1
(43) Pub. Date: May 11, 2023

(54) MATERIALS, INCLUDING NONWOVEN MATERIALS, AND METHODS THEREOF

(71) Applicant: National Nonwovens Inc., Easthampton, MA (US)

(72) Inventors: Conrad Anthony D'Elia, Westfield, MA (US); Mark Gregory Lawrence, Southampton, MA (US); Karen Spaulding Hawks, Westfield, MA (US)

(73) Assignee: National Nonwovens Inc., Easthampton, MA (US)

(21) Appl. No.: 17/915,441

(22) PCT Filed: Mar. 31, 2021
(86) PCT No.: PCT/US2021/025083

§ 371 Date: Sep. 28, 2022

Related U.S. Application Data
(60) Provisional application No. 63/003,825, filed on Apr. 1, 2020.

(51) Int. Cl. D04H 1/587; D04H 1/435; D04H 1/558; D04H 1/425; D04H 1/546

(52) U.S. Cl. CPC D04H 1/587; D04H 1/425; D04H 1/435; D04H 1/546; D04H 1/558; D10B 2201/22; D10B 2321/08; D10B 2331/04; D10B 2331/06

(57) ABSTRACT

Some aspects of the present disclosure generally relates to materials such as nonwoven materials, e.g., comprising fibers. Some examples of fibers include polyester, rayon, polyethylene terephthalate, polyvinyl acetate, etc. In some embodiments, the material may be functionalized in some manner. For example, a hydrophilic polymer such as polyethylene oxide may be bonded to at least some of the fibers and/or to itself. In some cases, the hydrophilic polymer may be substantially uniformly bonded to the fibers. In some cases, the functionalized material may be relatively permeable, which may allow fluids to flow therethrough. For example, the material may have a relatively high permeability to air, e.g., of at least 5 ft³/min/ft². Other aspects are generally directed to methods of making or using such materials, kits including such materials, etc.

### RELATED APPLICATIONS

This application claims the benefit of U.S. Provisional Pat. Application Serial No. 63/003,825, filed Apr. 1, 2020, entitled “Materials, Including Nonwoven Materials, and Methods Thereof,” by D’Elia, et al., incorporated herein by reference in its entirety.

### FIELD

Certain aspects of the present disclosure generally relates to materials such as nonwoven materials, including methods of making or using such materials.

### BACKGROUND

Nonwoven structures are typically made from fibers that are assembled together without weaving or knitting the individual fibers together. In some cases, the nonwoven structure may resemble a fabric material. The nonwoven structures may be formed by entangling the individual fibers together mechanically, thermally, chemically, etc. For example, the nonwoven structure may be fabricated using needlepunching or needlefelting technologies, where needles are used to mechanically entangle individual fibers together to form the nonwoven structure. Other technologies for forming nonwoven structures include thermal bonding, hydroentaglement, ultrasonic bonding, or chemical bonding. Such nonwoven structures may be used in a wide range of applications, for instance, for apparel, home furnishings, health care, engineering, industrial, or consumer goods.

### SUMMARY

Certain aspects of the present disclosure generally relates to materials such as nonwoven materials, including methods of making or using such materials. The subject matter of the present disclosure involves, in some cases, interrelated products, alternative solutions to a particular problem, and/or a plurality of different uses of one or more systems and/or articles.

Some aspects of the disclosure are generally directed to an article. The article may be a nonwoven material. In some cases, the article may be a woven material. The article may also include both nonwoven and woven portions, in certain embodiments.

For example, one aspect of the present disclosure is directed to a nonwoven material comprising fibers and polyethylene oxide bonded to at least some of the fibers and to itself. In some embodiments, the polyethylene oxide has an average molecular weight (Mᵥ) of between 5,000,000 and 12,000,000. In certain cases, the nonwoven material comprising the fibers and the polyethylene oxide has an air permeability of at least 5 ft³/min/ft² at a pressure differential of 0.5 inches of water and 77° F.

Another aspect is generally directed to a nonwoven material comprising fibers and polyethylene oxide bonded to at least some of the fibers and to itself. In some embodiments, the polyethylene oxide has an average molecular weight (Mᵥ) of between 5,000,000 and 12,000,000. In certain cases, the nonwoven material comprising the fibers and the polyethylene oxide has an air permeability of at least 15 m³/(min m²) at a pressure differential of 124 Pa and 25° C.

Yet another aspect is generally directed to a material comprising fibers and polyethylene oxide bonded to at least some of the fibers and to itself. In some embodiments, the polyethylene oxide has an average molecular weight (Mᵥ) of between 5,000,000 and 12,000,000. In certain cases, the material comprising the fibers and the polyethylene oxide has an air permeability of at least 5 ft³/min/ft² at a pressure differential of 0.5 inches of water and 77° F.

Still another aspect is generally directed to a material comprising fibers and polyethylene oxide bonded to at least some of the fibers and to itself. In some embodiments, the polyethylene oxide having an average molecular weight (Mᵥ) of between 5,000,000 and 12,000,000. In certain cases, the material comprising the fibers and the polyethylene oxide has an air permeability of at least 15 m³/(min m²) at a pressure differential of 124 Pa and 25° C.

Another aspect is generally directed to a material comprising fibers and polyethylene oxide bonded to at least some of the fibers and to itself. In some embodiments, the polyethylene oxide has an average molecular weight (Mᵥ) of between 5,000,000 and 12,000,000. In certain cases, the material is water-repellent as determined using ASTM D2842. In one embodiment, the material is a nonwoven material.

Still other aspects of the present disclosure are generally directed to certain methods. For example, one aspect is generally directed to a method comprising exposing a nonwoven material comprising fibers to polyethylene oxide, and bonding the polyethylene oxide to the nonwoven material and to itself. In some embodiments, the polyethylene oxide has an average molecular weight (Mᵥ) of between 5,000,000 and 12,000,000.

Another aspect is generally directed to a method comprising exposing a material comprising fibers to polyethylene oxide, and bonding the polyethylene oxide to the material and to itself. In some embodiments, the polyethylene oxide has an average molecular weight (Mᵥ) of between 5,000,000 and 12,000,000.

In another aspect, the present disclosure encompasses methods of making one or more of the embodiments described herein, for example, materials such as nonwoven materials. In still another aspect, the present disclosure encompasses methods of using one or more of the embodiments described herein, for example, materials such as nonwoven materials.

Other advantages and novel features will become apparent from the following detailed description of various non-limiting embodiments.

### DETAILED DESCRIPTION

Some aspects of the present disclosure generally relates to materials such as nonwoven materials, e.g., comprising fibers. Some examples of fibers include polyester, rayon, polyethylene terephthalate, polyvinyl acetate, etc. In some embodiments, the material may be functionalized in some manner. For example, a hydrophilic polymer such as polyethylene oxide may be bonded to at least some of the fibers and/or to itself. In some cases, the hydrophilic polymer may be substantially uniformly bonded to the fibers. In some cases, the functionalized material may be relatively permeable, which may allow fluids to flow therethrough. For example, the material may have a relatively high permeability to air, e.g., of at least 5 ft³/min/ft². Other aspects are generally directed to methods of making or using such materials, kits including such materials, etc.

Some aspects are generally directed to materials such as nonwoven materials that comprise fibers. One example of a fiber is a fiber comprising polyester polymer. Other non-limiting examples of fibers include fibers comprising polymers such as acrylic, polypropylene, polyaramid, polyamides or nylon, polyethylene terephthalate, rayon, lyocell, polyvinyl acetate, or the like. Further examples are described in more detail below. The fibers may be assembled into a material, for example, a nonwoven material, e.g., using techniques such as needlepunching, needlefelting, or other techniques such as those described herein. Other examples of materials include woven materials, knit materials, etc., such as those described herein.

In some cases, materials may be relatively light, yet strong, which may allow such materials to be used in applications such as a structural component within a car, truck, train, ship, boat, aircraft, or other vehicle, as part of a floor covering, as part of a fabric, as a construction material, or the like. In addition, in some embodiments, materials, including any of those described herein, including nonwoven and/or woven materials, may allow fluids such as gases or liquids to pass therethrough. For example, the material may be relatively porous. Such porous materials may be useful for a variety of applications. The porosity of the material can be determined, for example, as a permeability to air. For example, a material may be structured to have a high permeability to air, e.g., of at least 5 ft³/min/ft², or other permeabilities such as those described herein. Such permeabilities to air may be determined, e.g., using the final material, after any treatments to the material. For example, the material may be treated to include a hydrophilic polymer such as polyethylene oxide, e.g., as is discussed herein.

In addition, in certain embodiments, at least some of fibers within the material may be functionalized. For example, a hydrophilic polymer or a hydrophobic polymer may be bonded to at least some of the fibers, e.g., to alter the hydrophobicity of the fibers. This may allow the material to be used in various applications, e.g., such as for coating applications. Non-limiting examples of polymers that may be used to functionalize fibers include polyethylene oxide, polypropylene oxide, polyurethanes, fluorocarbons, silanes, polyvinyl alcohols, or the like. Such polymers may be bonded or coated onto the material using different techniques such as sintering, scatter-coating, spray-deposition, saturation, vapor deposition (e.g., chemical vapor deposition, physical vapor deposition, etc.), or the like. For example, in certain cases, heat and/or pressures may be used to bond the polymer to at least some of the fibers of the material.

As mentioned, a variety of fibers may be used in a material, according to various aspects. For instance, in one embodiment, some or all of the material may be a nonwoven material, such as those described herein. The nonwoven material can comprise any number of fiber types that are entangled together (e.g., without weaving) to form the nonwoven material. For instance, the nonwoven material may comprise one, two, three, or four more types of fibers, and the fibers can each independently be of any suitable composition, length, mass density, etc.

In other embodiments, however, some or all of the material may comprise woven fibers. For example, the fibers may be woven together in a unidirectional, a bidirectional, a multidirectional, a quasi-isotropic, etc. fashion. In certain embodiments, at least some of the fibers are substantially parallel, and/or orthogonally oriented relative to each other, although other configurations of fibers are also possible. In certain embodiments, the fibers may together define a fabric, a textile, or other substrate.

Examples of suitable fibers that may be used in a material (e.g., woven and/or nonwoven) that may be used include, but are not limited to, cotton or other plant fibers, wood fibers, animal fibers, glass fibers, fiberglass, carbon fibers, mineral fibers, metallic fibers, or synthetic or polymeric fibers, etc. For instance, the fibers may include polymers, e.g., comprising thermoplastic polymers and/or thermoset polymers. Non-limiting examples of polymeric fibers that may be used include polyamides such as polyamides or nylons, novoloid (e.g., Kynol® from American Kynol, novolacs, phenolic fibers, melamines, polyesters, polypropylenes, polyethylenes, polystyrenes, polyacrylic acids or acrylic, polyaramids, polyacrylonitriles, polyimides, polyetherimides, polyamideimides, polymethyl methacrylates, polyphenelene sulfides, lyocell (e.g., Tencel™), rayon, aramids (e.g., meta- or para-aramids, e.g., Kevlar® from Dupont), polybenzimidazoles, polyphenylenebenzobizoxazoles, aromatic polyketones (e.g., polyetheretherketones, polyetherketoneketones, etc.), polyacetates (e.g., polyvinyl acetates), polysulfones, polyethersulfones, polyurethanes, polyisobutylenes, liquid crystal polymers, polyethylene terephthalate (PET), poly(paraphenylene terephthalamide), polylactic acids, etc. A polymeric fiber in the material may comprise one or more than one of these polymers, and/or other polymers, and/or a polymeric fiber can be formed from or consist essentially of one type of polymer. In some cases, the material can include one, two, three, or more fiber types having different compositions, lengths, diameters, densities, etc.

The polymers may be amorphous, crystalline, semicrystalline, etc. In some cases, polymeric fibers within the material may exhibit one or more of these properties. For instance, the polymer fibers may be partially amorphous and partially crystalline. In addition, it should be noted that certain polymers can be made to be amorphous, crystalline, or semicrystalline, depending on the synthesis technique, and can also be used in some embodiments. In some cases, the polymers may include semicrystalline regions that may be, e.g., roughly 1 micrometer in size, although the degree of crystallinity and the size of the semicrystalline regions may vary based on factors such as the size and orientation of the molecular chains, the synthesis technique, and the monomers forming the polymer. The degree of crystallinity in a polymer can be determined using techniques such as X-ray diffraction (XRD) or other X-ray scattering techniques known to those of ordinary skill in the art. In some cases, the degree of crystallinity of an amorphous polymer may be less than about 25%, less than about 20%, less than about 15%, less than about 10%, or less than about 5%. In addition, an amorphous polymer may be determined in some embodiments by determining its melting temperature; in some cases, an amorphous polymer will not exhibit a sharp melting point (e.g., due to a lack of crystalline regions or domains), and in some cases, the amorphous polymer may not even exhibit a definable or determinable melting point.

The fibers within the article may be of any suitable length, size, composition, diameter, mass density, etc. Non-limiting examples of such fibers are discussed in detail herein. However, it should also be understood that the fibers within the material can also have dimensions, physical properties, and/or compositions that differ somewhat from the initial fibers, e.g., due to the effects of heating, pressure, additives, or the like, for instance, as discussed herein.

In one set of embodiments, the fibers within the material may have any suitable diameter (or smallest cross-sectional dimension for fibers that are not in the form of circular cylinders). As non-limiting examples, the material may comprise fibers having an average diameter of less than about 500 micrometers, less than about 400 micrometers, less than about 300 micrometers, less than about 200 micrometers, less than about 100 micrometers, less than about 90 micrometers, less than about 80 micrometers, less than about 70 micrometers, less than about 60 micrometers, less than about 50 micrometers, less than about 40 micrometers, less than about 30 micrometers, less than about 25 micrometers, less than about 20 micrometers, less than about 15 micrometers, less than about 10 micrometers, less than about 5 micrometers, less than about 1 micrometer, less than about 0.5 micrometers, less than about 0.3 micrometers, less than about 0.1 micrometers, less than about 0.05 micrometers, etc. In some embodiments, the fibers may have an average diameter of at least about 0.05 micrometers, at least about 0.1 micrometers, at least about 0.3 micrometers, at least about 0.5 micrometers, at least about 1 micrometer, at least about 5 micrometers, at least about 10 micrometers, at least about 15 micrometers, at least about 20 micrometers, at least about 25 micrometers, at least about 30 micrometers, at least about 40 micrometers, at least about 50 micrometers, at least about 60 micrometers, at least about 70 micrometers, at least about 80 micrometers, at least about 90 micrometers, at least about 100 micrometers, at least about 200 micrometers, at least about 300 micrometers, at least about 400 micrometers, etc. Suitable combinations of any of these are also contemplated in some embodiments, e.g., the fibers may have a diameter of between about 50 micrometers and 100 micrometers. If more than one type of fiber is present in the material, the fibers independently can have the same or different diameters. In addition, the diameters may be substantially the same, or there may be a range of diameters for fibers with substantially the same composition within the material. Also, fibers having different diameters within a material can independently have the same or different compositions.

The fibers within the article can also have any suitable length, and the lengths of the fibers may be substantially the same, or there may be a range of lengths present within the material for fibers with substantially the same composition. For example, the fibers may have a length of about 15 inches or less, about 12 inches or less, about 11 inches or less, about 10 inches or less, about 9 inches or less, about 8 inches or less, about 7 inches or less, about 6 inches or less, about 5 inches or less, about 4 inches or less, about 3 inches or less, about 2 inches or less, or about 1 inch or less, depending on the embodiment. (1 inch is 25.4 mm.) In some embodiments, the fibers may also have a length of at least about 1 inch, at least about 2 inches, at least about 3 inches, at least about 4 inches, at least about 5 inches, at least about 6 inches, at least about 7 inches, at least about 8 inches, at least about 9 inches, at least about 10 inches, at least about 11 inches, at least about 12 inches, etc., and/or combinations of any of these (e.g., the fibers within the material may have a length of between about 3 inches and about 8 inches). If more than one fiber type is present in the material, the fiber types can independently have the same or different lengths. Fibers having different lengths within a material can also independently have the same or different compositions. In addition, the lengths may be substantially the same, or a range of lengths may be present for fiber types with substantially the same composition within the material.

In addition, in some embodiments, the material comprises fibers having one or more “weights,” or more accurately, mass densities. For example, the material may comprise fibers having an average linear mass density of 20 Denier or less, 18 Denier or less, 16 Denier or less, 15 Denier or less, 14 Denier or less, 13 Denier or less, 12 Denier or less, 11 Denier or less, 10 Denier or less, 9 Denier or less, 8 Denier or less, 7 Denier or less, 6 Denier or less, 5 Denier or less, 4 Denier or less, 3 Denier or less, 2.5 Denier or less, 2 Denier or less, 1.5 Denier or less, 1 Denier or less, 0.5 Denier or less, 0.3 Denier or less, 0.2 Denier or less, 0.1 Denier or less, or 0.05 Denier or less. (1 Denier is the mass in grams for 9.000 linear meters of fiber; expressed as a ratio, this becomes an average linear mass density of the fiber.) In some cases, the material comprises fibers having average linear mass densities at least 0.05 Denier, at least 0.1 Denier, at least 0.2 Denier, at least 0.3 Denier, at least 0.5 Denier, of at least 1 Denier, at least 1.5 Denier, at least 2 Denier, at least 2.5 Denier, at least 3 Denier, at least 4 Denier, at least 5 Denier, at least 6 Denier, at least 7 Denier, at least 8 Denier, at least 9 Denier, at least 10 Denier, at least 11 Denier, at least 12 Denier, at least 13 Denier, at least 14 Denier, at least 15 Denier, at least 16 Denier, 18 Denier, etc. Suitable combinations of any of these are also contemplated in other embodiments, e.g., the material may comprise fibers having an average linear mass density of greater than 2 Denier and less than 6 Denier. In addition, the densities may be substantially the same, or there may be a range of densities present, for fibers with substantially the same composition within the material.

In certain embodiments, the material is hydrophobic, or is treated to render it hydrophobic, for example, using a water repellent. For example, the material may have a water contact angle of greater than about 75°, greater than about 90°, greater than about 100°, greater than about 120°, greater than about 135°, etc. Examples of suitable treatments or water repellents include, but are not limited to, fluorinated hydrocarbons (e.g., having 3, 4, 5, 6, 7, or 8 carbons) such as fluoroalkyl esters, perfluoroacrylates, trifluorinated hydrocarbons, tetrafluorinated hydrocarbons, fluorinated acrylates, perfluoroacrylates, silicones such as reactive organosilicones, polysiloxanes such as polydimethylsiloxanes or polymethylhydrogensiloxanes, or the like. In one set of embodiments, the material is hydrophobic or water-repellent, and/or is treated such that it absorbs less than 4% water by weight after 96 hours, e.g., as discussed in the ASTM D2842 water absorption test (Standard Test Method for Water Absorption of Rigid Cellular Plastics).

In some aspects, the fibers are formed into a material, such as a nonwoven material. Such fibers can be formed into a material using a variety of techniques. For example, a material may comprise a nonwoven portion which, in certain embodiments, may be fabricated from fibers such as those described herein using techniques such as needlepunching or needlefelting. Other methods for forming nonwoven materials include hydroentaglement, or ultrasonic bonding. Still other non-limiting examples of methods for forming nonwoven material materials include chemical bonding (e.g., using a suitable bonding agent, such as water, an adhesive, etc.), spin bonding, flash spinning, melt-blowing, acid bonding, thermal bonding (e.g., including high loft thermal bonding), point bonding, etc. Those of ordinary skill in the art will be aware of these and a variety of other methods for forming fibers into a nonwoven material.

In addition, at least some of the fibers can be formed into a woven material, in accordance with certain embodiments. Fibers such as those described herein may be formed into a material using a variety of techniques. For instance, fibers may be woven together to form a fabric or a layer using techniques such as weaving or interweaving, knitting, braiding, intertwining, twisting, inter-looping, or the like.

In some embodiments, the material may include portions that comprise nonwoven materials, and/or portions that comprise woven materials, and/or portions that comprise other materials, such as foams. For example, a nonwoven material and a woven material may be joined together, for instance, using needlepunching, needlefelting, adhesives, hydroentaglement, ultrasonic bonding, or other techniques such as those described herein.

The material may have any suitable shape or size. In some cases, the material may be substantially planar, although this is not a requirement for all embodiments. For example, in some applications, the material may be shaped or molded to have different configurations, such as a specific shape (e.g., an irregular shape, plane curve, manifold, etc.) that is useful for a certain application.

The material can have any suitable thickness or smallest dimension, e.g., if the material is substantially planar. For example, the smallest dimension of the material, may be at least about 0.01 inches, at least about 0.02 inches, at least about 0.03 inches, at least about 0.05 inches, at least about 0.1 inches, at least about 0.25 inches, at least about 0.5 inches, at least about 0.75 inches, at least about 1 inch, at least about 1.25 inches, at least about 1.5 inches, at least about 1.75 inches, at least about 2 inches, at least about 2.25 inches, at least about 2.5 inches, at least about 2.75 inches, at least about 3 inches, at least about 3.5 inches, at least about 4 inches, at least about 4.5 inches, at least about 5 inches, at least about 6 inches, at least about 7 inches, at least about 8 inches, at least about 9 inches, at least about 10 inches, at least about 12 inches, etc. In addition, in some cases, the material may be no more than about 13 inches, no more than about 12 inches, no more than about 10 inches, no more than about 9 inches, no more than about 8 inches, no more than about 7 inches, no more than about 6 inches, no more than about 5 inches, no more than about 4.5 inches, no more than about 4 inches, no more than about 3.5 inches, no more than about 3 inches, no more than about 2.75 inches, no more than about 2.5 inches, no more than about 2.25 inches, no more than about 2 inches, no more than about 1.75 inches, no more than about 1.5 inches, no more than about 1.25 inches, no more than about 1 inch, no more than about 0.75 inches, no more than about 0.5 inches, no more than about 0.25 inches, no more than about 0.1 inches, no more than about 0.05 inches, no more than about 0.03 inches, no more than about 0.02 inches, etc. In some embodiments, the material falls within any suitable combination of these ranges, e.g., between 0.5 inches and 2 inches in thickness or smallest dimension.

In certain embodiments, the material may have a structure that allows it to have a relatively low fiber density. This allows the material to be relatively light, yet strong in some embodiments, and such materials may be used for a variety of different applications.

The fiber density of a material can be determined in a variety of ways. For example, in one set of embodiments, the density or areal weights of the material may be determined. For instance, a material may exhibit a areal weights of at least 0.2 oz/yd², at least 0.4 oz/yd², at least 0.5 oz/yd², at least 0.6 oz/yd², at least 0.8 oz/yd², at least 1.0 oz/yd², at least 1.2 oz/yd², at least 1.4 oz/yd², at least 1.5 oz/yd², at least 1.6 oz/yd², at least 1.7 oz/yd², at least 1.8 oz/yd², at least 2.0 oz/yd², at least 2.2 oz/yd², at least 2.4 oz/yd², at least 2.5 oz/yd², at least 2.6 oz/yd², at least 2.8 oz/yd², at least 3.0 oz/yd², at least 3.2 oz/yd², at least 3.3 oz/yd², at least 3.4 oz/yd², at least 3.5 oz/yd², at least 3.6 oz/yd², at least 3.8 oz/yd², at least 4.0 oz/yd², at least 5.0 oz/yd², at least 7 oz/yd², at least 10 oz/yd², at least 15 oz/yd², at least 20 oz/yd², at least 25 oz/yd², at least 30 oz/yd², at least 35 oz/yd², at least 40 oz/yd², at least 45 oz/yd², at least 50 oz/yd², etc. In addition, in certain embodiments, the areal weights may be no more than 50 oz/yd², no more than 45 oz/yd², no more than 40 oz/yd², no more than 35 oz/yd², no more than 25 oz/yd², no more than 20 oz/yd², no more than 15 oz/yd², no more than 10 oz/yd², no more than 7 oz/yd², no more than 5.0 oz/yd², no more than 4.5 oz/yd², no more than 4.0 oz/yd², no more than 3.8 oz/yd², no more than 3.6 oz/yd², no more than 3.5 oz/yd², no more than 3.4 oz/yd², no more than 3.3 oz/yd², no more than 3.2 oz/yd², no more than 3.0 oz/yd², no more than 2.8 oz/yd², no more than 2.6 oz/yd², no more than 2.5 oz/yd², no more than 2.4 oz/yd², no more than 2.2 oz/yd², no more than 2.0 oz/yd², no more than 1.8 oz/yd², no more than 1.6 oz/yd², no more than 1.5 oz/yd², no more than 1.4 oz/yd², no more than 1.2 oz/yd², no more than 1.0 oz/yd², no more than 0.8 oz/yd², no more than 0.6 oz/yd², no more than 0.5 oz/yd², no more than 0.4 oz/yd², no more than 0.2 oz/yd², etc. Combinations of any of these are possible. For instance, the material may exhibit a density of between 0.4 oz/yd² and 3.5 oz/yd², between 1 oz/yd² and 2 oz/yd², between 2 oz/yd² and 3 oz/yd², between 0.8 oz/yd² and 1.5 oz/yd², between 0.8 oz/yd² and 1.2 oz/yd², between 0.5 oz/yd² and 1 oz/yd², etc. As another example, the material may exhibit a density of between 1.7 oz/yd² and 3.3 oz/yd². (1 oz is 28.3495 g and 1 yd is 0.9144 m.) In addition, it should be understood that the material may include one or more layers within the composition, e.g., formed from nonwoven and/or woven materials. In addition, the areal weights may be determined, in some cases, for an untreated or a treated material, e.g., including treatment with a hydrophilic polymer such as polyethylene oxide. For example, in one set of embodiments, the areal weights above are those for an untreated material.

In some embodiments, fluids such as gases or liquids may be able to flow through spaces between the fibers in the material, and the spaces may be characterized as having an equivalent diameter or porosity that gases are able to flow through. Thus, in another set of embodiments, fiber density of a material, such as a nonwoven material and/or a woven material, can be determined based on the porosity of the material. The porosity within the material may be determined by any suitable technique known to those of ordinary skill in the art, e.g., through microscopy or electron microscopy, capillary flow porometry, etc. For example, in one set of embodiments, the material has an number average porosity (with pore size being the smallest cross-sectional dimension of the pore) determined by microscopy or a mean flow pore size determined by porometry of less than about 1 cm, less than about 5 mm, less than about 3 mm, less than about 1 mm, less than about 0.5 mm, or less than about 0.3 mm. The average porosity may also be less than about 100 micrometers, less than about 90 micrometers, less than about 80 micrometers, less than about 70 micrometers, less than about 60 micrometers, less than about 50 micrometers, less than about 40 micrometers, less than about 30 micrometers, less than about 25 micrometers, less than about 20 micrometers, less than about 15 micrometers, less than about 10 micrometers, less than about 5 micrometers, less than about 1 micrometer, etc. The material can also have a porosity of at least about 1 micrometer, at least about 5 micrometers, at least about 10 micrometers, at least about 15 micrometers, at least about 20 micrometers, at least about 25 micrometers, at least about 30 micrometers, at least about 40 micrometers, at least about 50 micrometers, at least about 60 micrometers, at least about 70 micrometers, at least about 80 micrometers, at least about 90 micrometers, at least about 100 micrometers, at least about 300 micrometers, at least about 500 micrometers, at least about micrometers, at least about 1 mm, at least about 3 mm, etc. Combinations of any of these are also possible; for example, the material may have a porosity between about 30 micrometers and about 1 mm in one embodiment.

In yet another set of embodiments, the density of the material may be determined using air permeability; for example, the material may have a sufficiently low density of fibers such that air can readily flow through the material. One way of measuring this is by applying a pressure differential of 0.5 inches of water (124 Pa) at 77° F. (25° C.) across the material, and determining the permeability of air through the material. (1 in H₂O is 248.84 Pa.) Such permeabilities to air may be determined using the final material, e.g., after any treatments such as those discussed herein. In some cases, this may be determined for a material having a thickness of between 0.01 inches and 0.1 inches, or other thicknesses such as are described herein. For instance, in some cases, the air permeability of the material may be at least 5 CFM/ft² (i.e., ft³/min/ft²) (CFM or cubic feet per minute per surface area as measured in square feet) (1.5 m³/min/m²)), and in some cases, at least 10 ft³/min/ft², at least 15 ft³/min/ft², at least 20 ft³/min/ft², at least 25 ft³/min/ft², at least 50 ft³/min/ft², at least 75 ft³/min/ft², at least 100 ft³/min/ft², at least125 ft³/min/ft², at least 150 ft³/min/ft², at least 200 ft³/min/ft², at least 250 ft³/min/ft², at least 300 ft³/min/ft², at least 350 ft³/min/ft², at least 400 ft³/min/ft², at least 450 ft³/min/ft², at least 500 ft³/min/ft², at least 550 ft³/min/ft², at least 600 ft³/min/ft², at least 700 ft³/min/ft², at least 750 ft³/min/ft², at least 800 ft³/min/ft², at least 900 ft³/min/ft², at least 1000 ft³/min/ft², etc. In addition, in certain embodiments, the air permeability of the material may be no more than 1000 ft³/min/ft², no more than 900 ft³/min/ft², no more than 800 ft³/min/ft², no more than 750 ft³/min/ft², no more than 700 ft³/min/ft², no more than 600 ft³/min/ft², no more than 550 ft³/min/ft², no more than 500 ft³/min/ft², no more than 450 ft³/min/ft², no more than 400 ft³/min/ft², no more than 350 ft³/min/ft², no more than 300 ft³/min/ft², no more than 250 ft³/min/ft², no more than 200 ft³/min/ft², no more than 150 ft³/min/ft², no more than 125 ft³/min/ft², no more than 100 ft³/min/ft², no more than 75 ft³/min/ft², no more than 50 ft³/min/ft², no more than 25 ft³/min/ft², no more than 20 ft³/min/ft², no more than 15 ft³/min/ft², no more than 10 ft³/min/ft², no more than 5 ft³/min/ft², etc. Combinations of any of these are possible. For instance, the material may exhibit an air permeability of between 50 ft³/min/ft² and 100 ft³/min/ft², between 200 ft³/min/ft² and 300 ft³/min/ft², between 100 ft³/min/ft² and 200 ft³/min/ft², between 500 ft³/min/ft² and 600 ft³/min/ft², etc. In addition, the material may be limited by its structural integrity in some cases, i.e., a material having an insufficiently dense density of fibers will not be able to support its own weight, and accordingly its air permeability cannot be measured.

In addition, in one set of embodiments, the permeability to air of the material can be determined in the absence of any treatments. For example, a material may include a hydrophilic polymer such as polyethylene oxide, e.g., bonded to at least some of the fibers and/or to itself, and such polymers can be removed to determine the permeability to air of the untreated material, e.g., using methods known to those of ordinary skill in the art. For instance, exposure to excess amounts of a solution of sodium succinate may be used to remove polyethylene oxide, and then the material, after removal of treatment, may be assessed for its permeability to air. For instance, in some cases, the air permeability of the material after treatment removal may be at least 50 ft³/min/ft², at least 75 ft³/min/ft², at least 100 ft³/min/ft², at least 125 ft³/min/ft², at least 150 ft³/min/ft², at least 200 ft³/min/ft², at least 250 ft³/min/ft², at least 300 ft³/min/ft², at least 350 ft³/min/ft², at least 400 ft³/min/ft², at least 450 ft³/min/ft², at least 500 ft³/min/ft², at least 550 ft³/min/ft², at least 600 ft³/min/ft², at least 700 ft³/min/ft², at least 750 ft³/min/ft², at least 800 ft³/min/ft², at least 900 ft³/min/ft², at least 1000 ft³/min/ft², etc. In addition, in certain embodiments, the air permeability of the material may be no more than 1000 ft³/min/ft², no more than 900 ft³/min/ft², no more than 800 ft³/min/ft², no more than 750 ft³/min/ft², no more than 700 ft³/min/ft², no more than 600 ft³/min/ft², no more than 550 ft³/min/ft², no more than 500 ft³/min/ft², no more than 450 ft³/min/ft², no more than 400 ft³/min/ft², no more than 350 ft³/min/ft², no more than 300 ft³/min/ft², no more than 250 ft³/min/ft², no more than 200 ft³/min/ft², no more than 150 ft³/min/ft², no more than 125 ft³/min/ft², no more than 100 ft³/min/ft², no more than 75 ft³/min/ft², no more than 50 ft³/min/ft², no more than 25 ft³/min/ft², no more than 20 ft³/min/ft², no more than 15 ft³/min/ft², no more than 10 ft³/min/ft², no more than 5 ft³/min/ft², etc. Combinations of any of these are possible. For instance, the material may exhibit an air permeability of between 50 ft³/min/ft² and 100 ft³/min/ft², etc.

Other materials can also be present within the material in accordance with certain aspects. For example, in one set of embodiments, hydrophobicity and/or hydrophilicity of the material may be controlled. In certain embodiments, the material may be hydrophobic or hydrophilic, and/or may be treated to render it more hydrophobic or hydrophilic. For example, the may have a water contact angle of greater than about 75°, greater than about 90°, greater than about 100°, greater than about 120°, greater than about 135°, etc., for more hydrophobic materials, or a water contact angle of less than about 100°, less than about 90°, less than about 75°, less than about 60°, less than about 45°, less than about 30°, etc., for more hydrophilic materials.

Accordingly, in certain embodiments, the material may be functionalized in some manner, e.g., to render it more hydrophobic or hydrophilic. For example, an agent, such as a polymer, may be bonded to and/or coated on at least some of the fibers and/or to itself in order to render the material more hydrophobic or hydrophilic. Non-limiting examples of such agents include fluorinated hydrocarbons (e.g., having 3, 4, 5, 6, 7, or 8 carbons) such as fluoroalkyl esters, perfluoroacrylates, trifluorinated hydrocarbons, tetrafluorinated hydrocarbons, fluorinated acrylates, perfluoroacrylates, silicones such as reactive organosilicones, polysiloxanes such as polydimethylsiloxanes or polymethylhydrogensiloxanes, polyethylene oxide, polypropylene oxide, polyurethanes, polyvinylalcohols, borax, clays, or the like. Thus, for example, a polymer such as polyethylene oxide may be bonded to and/or coated on at least some of the fibers of the material, and/or to itself in some cases. Agents such as these can readily be obtained commercially. For instance, polyethylene oxide is commercially available under trade names such as Polyox and Ucarfloc.

In one set of embodiments, the polymer may be applied to the material as particles, for example, in the case of certain high molecular weight polymers. In some cases, the particles may be applied as relatively smaller and/or more uniform particles. Such particle distributions may be produced, for example, using techniques such as sifting or filtration. For example, the particles may be applied to have an average particles size of less than 1000 micrometers, less than 900 micrometers, less than 800 micrometers, less than 700 micrometers, less than 600 micrometers, 500 micrometers, less than 400 micrometers, less than 300 micrometers, less than 250 micrometers, less than 200 micrometers, less than 150 micrometers, less than 100 micrometer, 50 micrometers, less than 40 micrometers, less than 30 micrometers, less than 25 micrometers, less than 20 micrometers, less than 15 micrometers, less than 10 micrometers, etc.

In certain cases, the agent may be bonded, chemically and/or physically, to at least 10%, at least 20%, at least 30%, at least 40%, at least 50%, at least 60%, at least 70%, at least 80%, at least 90%, or about 100% of the fibers within a material. The agent may be bonded to and/or coated on some or all of the fibers of the material, e.g., internally. In some embodiments, however, at least some of the agent may be present as a film or a coat on a surface of the material.

As a non-limiting example, in some cases, a hydrophilic polymer may be used that is able to attract and/or is able to chemically complex to water, e.g., by hydrogen bonding. For instance, certain embodiments are directed to a chemical matrix that forms a resin bonding the fibers and hydrophilic polymer into a system capable of retaining water, e.g., without releasing significant amounts of hydrophilic polymer. In some cases, for instance, there may be no more than 7 ppm (by mass), no more than 6 ppm, no more than 5 ppm, no more than 4 ppm, no more than 3 ppm, no more than 2 ppm, no more than 1 ppm, no more than 700 ppb, no more than 500 ppb, no more than 300 ppb, no more than 200 ppb, no more than 100 ppb, no more than 70 ppb, no more than 50 ppb, no more than 30 ppb, no more than 20 ppb, no more than 10 ppb of hydrophilic polymer within a fluid exposed to the material, e.g., a liquid such as the hydrocarbons discussed herein. In some cases, there may be no or undetectable concentrations of hydrophilic polymer within the fluid, e.g., using current detection technologies.

The hydrophilic polymer may be disposed in the material to attract water, in some embodiments. For instance, the hydrophilic polymer may be distributed or incorporated within an isotropic or array of fibers, e.g., such that it is bonded substantially uniformly within the material. Bonding of the hydrophilic polymer to the material may be chemical and/or physical, and any of the techniques described herein may be used to cause such bonding to occur. In some cases, the bonding may be such that the material remains porous or air-permeable, e.g., as discussed herein. Such materials may subsequently be used to attract water, e.g., from a fluid, e.g., due to hydrogen bonding of free water to the hydrophilic polymer, and can be used, for example, to remove water from a liquid and/or preventing water from passing through the material, for example, in recovery applications, for example for liquids comprising hydrocarbons.

In one set of embodiments, the uniformity of bonding of the hydrophilic polymer, e.g., polyethylene oxide, to the material may be determined by determining the difficulty of passing water through the material. For example, a sample of material may be exposed to water at a relatively high pressure, and the ability of water to pass through the sample may be used to determine the uniformity of bonding. For example, embodiments where the hydrophilic polymer is not substantially uniformly distributed within the material may result in “gaps” of coverage, i.e., where water can seep through the material relatively unhindered, thereby achieving breakthrough and passage across the material in a relatively short period of time. In contrast, more uniform bonding may result in resistances to water transport through the material of at least 5 minutes, at least 10 minutes, at least 15 minutes, at least 30 minutes, at least 1 hour, at least 2 hours, at least 3 hours, at least 5 hours, at least 10 hours, etc. In some embodiments, the sample may be have a thickness of at least 1 mm, 2 mm, at least 0.1 inches, at least 0.25 inches, at least 0.5 inches, at least 1 inch, at least 1.5 inches, at least 2 inches, etc., and/or no more than 3 inches, no more than 2 inches, no more than 1.5 inches, no more than 1 inch, no more than 0.5 inches, no more than 0.25 inches, no more than 0.1 inches, etc.

The agent may be bonded to the material, e.g., chemically and/or physically, using any suitable technique. The agent may applied in any suitable form, e.g., as a liquid, as a solid or a powder, or the like. One example of an application technique is scatter-coating. In some cases, polymeric powder may be spread or scattered onto a material, e.g., by spraying it, using a rotating scatter roller, scatter-coating, spray-deposition, or the like. Other examples include sintering techniques, where heat and/or pressure may be applied to the material to cause bonding with the agent, e.g., chemically and/or physically. Still additional non-limiting examples include spin-bonding, acid bonding, thermal bonding, high loft thermal bonding, point bonding, and the like. One, two, or more such techniques may be used in various embodiments.

In some cases, the agent is bonded to the material, e.g., chemically. For example, a polymer such as polyethylene oxide may be chemically bonded to or functionalized with a fiber within a material. Polymers that can be bonded include polyethylene oxide, polypropylene oxide, or any other polymers described herein.

The polymer may have any suitable molecular weight in accordance with various embodiments. In some embodiments, the polymer may have a range of average molecular weights (Mᵥ, viscosity average molecular weight) and/or polydispersities. As non-limiting examples, in some embodiments, the polyethylene oxide may have an average molecular weight of at least 1,000, at least 3,000, at least 5,000, at least 10,000, at least 30,000, at least 50,000, at least 100,000, at least 300,000, at least 500,000, at least 1,000,000, at least 2,000,000, at least 3,000,000, at least 4,000,000, at least 5,000,000, at least 6,000,000, at least 7,000,000, at least 8,000,000, at least 9,000,000, at least 10,000,000, at least 11,000,000, etc. In addition, in some embodiments, the polyethylene oxide may have an average molecular weight of less than 12,000,000, less than 11,000,000, less than 10,000,000, less than 9,000,000, less than 8,000,000, less than 7,000,000, less than 6,000,000, less than 5,000,000, less than 4,000,000, less than 3,000,000, less than 2,000,000, less than 1,000,000, less than 500,000, less than 300,00, less than 100,000, less than 50,000, less than 30,000, less than 10,000, less than 5,000, less than 3,000, less than 1,000, etc. Any combination of any of these is also possible in various embodiments. For example, the average molecular weight may be between 5,000 and 10,000, between 100,000 and 500,000, between 5,000,000 and 12,000,000, between 5,000,000 and 7,000,000, between 9,000,000 and 11,000,000, etc. As another example, the average molecular weight may be between 7,000,000 and 9,000,000.

The agent may be applied to the material at any suitable amount or concentration. For instance, for a material having a thickness of between 0.01 inches and 0.1 inches, the agent may be present at an amount of at least 1 g/yd², at least 2 g/yd², 3 g/yd², at least 5 g/yd², at least 10 g/yd², at least 15 g/yd², at least 20 g/yd², at least 25 g/yd², at least 30 g/yd², at least 40 g/yd², at least 50 g/yd², at least 60 g/yd², at least 70 g/yd², at least 80 g/yd², at least 90 g/yd², at least 100 g/yd², at least 120 g/yd², at least 140 g/yd², at least 160 g/yd², at least 180 g/yd², at least 200 g/yd², at least 220 g/yd², at least 240 g/yd², at least 250 g/yd², at least 300 g/yd², at least 350 g/yd², at least 400 g/yd², at least 450 g/yd², at least 500 g/yd², etc. In addition, in certain embodiments, the agent may be applied at no more than 500 g/yd², no more than 450 g/yd², no more than 400 g/yd², no more than 350 g/yd², no more than 300 g/yd², no more than 250 g/yd², no more than 240 g/yd², no more than 220 g/yd², no more than 200 g/yd², no more than 180 g/yd², no more than 160 g/yd², no more than 140 g/yd², no more than 120 g/yd², no more than 100 g/yd², no more than 90 g/yd², no more than 80 g/yd², no more than 70 g/yd², no more than 60 g/yd², no more than 50 g/yd², no more than 40 g/yd², no more than 30 g/yd², no more than 25 g/yd², no more than 20 g/yd², no more than 15 g/yd², no more than 10 g/yd², no more than 5 g/yd², etc. Combinations of any of these are possible. For instance, the agent may be applied at between 20 g/yd² and 200 g/yd², between 100 g/yd² and 300 g/yd², between 120 g/yd² and 180 g/yd², between 70 g/yd² and 160 g/yd², between 70 g/yd² and 90 g/yd², etc.

In one set of embodiments, the agent is a substantially uniformly bonded to the material. For instance, the agent may be distributed such that the concentration of the agent within different portions of the material exhibits a coefficient of variation of less than 1, less than 0.8, less than 0.6, less than 0.5, less than 0.4, less than 0.3, less than 0.2, or less than 0.1.

In addition, in certain cases, the uniformity of the agent may be determined experimentally. For example, a fluid may be placed on one side of a sample of material, and under pressure, forced through to the other side. The amount of pressure actually needed to cause the fluid to pass through the material may be a function of the uniformity of the agent within the material; regions where agent is not present may be weak spots that allow the fluid to pass through more readily. Thus, by determining the pressure needed to cause fluid transport, the uniformity of the agent may be determined.

As an example, in one embodiment, the material may have a thickness of 1 inch. In some cases, the applied pressure may be least 5 psi (gauge pressure), at least 10 psi, at least 20 psi, at least 30 psi, at least 40 psi, at least 50 psi, at least 60 psi, at least 70 psi, at least 80 psi, at least 90 psi, at least 100 psi, at least 110 psi, at least 120 psi, at least 130 psi, at least 140 psi, at least 150 psi, at least 160 psi, at least 170 psi, at least 180 psi, at least 190 psi, at least 200 psi, at least 250 psi, at least 300 psi, at least 350 psi, at least 400 psi, at least 450 psi, at least 500 psi, etc. However, in some cases, the pressure may be gradually increased until the fluid starts to pass through the material.

The fluid may be one that is unreactive towards the agent, although in other cases, the fluid may react with the agent. It should be understood that such fluids, by reacting the agent, may be able to weaken the material, e.g., allowing fluid transport to occur at lower pressures, as compared to unreactive fluids. More uniform distribution of the agent, however, may allow such materials to resist, which may be determined, for example, by greater pressures needed to cause fluid to pass through the material.

Examples of unreactive fluids (for example, with respect to agents, e.g., polyethylene oxide) include, but are not limited to, hydrocarbons and hydrocarbon-based fluid. In some cases, the unreactive fluid is not soluble in water, and/or the unreactive fluid, when exposed to water, partitions or forms a separate phase. Specific non-limiting examples of unreactive fluids include kerosene, ethane, propane, avgas, diesel fuel, naphtha, gasoline, lamp oil, mineral oil, naphtha, jet fuel, paraffin, or the like. In some cases, combinations of more than one or more such fluids may be present.

Examples of reactive fluids (for example, with respect to agents, e.g., polyethylene oxide) include, but are not limited to, water or other aqueous fluids, e.g., that can dissolve or otherwise react with polyethylene oxide or other hydrophilic polymers such as those described herein. In some cases, the reactive fluid is soluble in water, e.g., it does not partition from water.

Some non-limiting examples of materials that can be coated or bonded with agents such as polyethylene oxide include chemical-bonded materials, spunbonded material, acid-bonded material, thermal bonded material, high loft thermal bonded materials, point-bonded materials, hydroentangled materials (e.g., plain and aperture hydroentanglement), needlepunched materials (e.g., using carded webs, airlaid webs, etc.), melt-blown materials, open cell foams, woven micron screens, and the like. The material may include nonwoven and/or woven portion, e.g., as discussed herein.

As mentioned, in some aspects, sintering techniques, including heat and/or pressure, may be applied to the material to cause bonding with the agent, e.g., chemically and/or physically. For instance, in one set of embodiments, heat may be applied to bond an agent such as polyeythene oxide to the material, e.g., chemically and/or physically (for example, by causing at least some of the polyeythene oxide to melt and solidify onto the fibers of the material). In some embodiments, the material may be heated to a temperature of at least about 60° F., at least about 80° F., at least about 100° F., at least about 120° F., at least about 140° F., at least about 160° F., at least about 180° F., at least about 200° F., at least about 220° F., at least about 240° F., at least about 260° F., at least about 280° F., at least about 300° F., at least about 320° F., at least 330° F., at least about 340° F., at least about 360° F., at least about 380° F., at least about 400° F., etc. However, in some cases, the temperature may be no more than about 400° F., no more than about 380° F., no more than about 360° F., no more than about 340° F., no more than 330° F., no more than about 320° F., no more than about 300° F., no more than about 280° F., no more than about 260° F., no more than about 240° F., no more than about 220° F., no more than about 200° F., no more than about 180° F., no more than about 160° F., no more than about 140° F., no more than about 120° F., no more than about 100° F., no more than about 80° F., etc. In some embodiments, the temperature may also be heated to a temperature that is within any of these values, e.g., between about 180° F. and 340° F.

In certain embodiments, heat can be applied to substantially all or only a portion of the material, depending on the application. Thus, for example, the material can be substantially uniformly heated, or different portions of the material may be subjected to different temperatures.

Any suitable technique may be used to heat the material. Examples of suitable techniques include, but are not limited to, heating within an oven or other enclosed temperature controlled environment, electrically resistive heating, radiative heating, exposure to radiation (e.g., infrared radiation), application of heat sources, e.g. via direct surface contact, to the material, or the like. Heating may occur via conduction, convection, radiation, and/or combinations of these and or other techniques.

In some cases, the heat may be applied in a relatively uniform manner. For instance, in one set of embodiments, the heat as applied such that no portion of the material is heated to a temperature no more than 25° F., no more than 20° F., no more than 15° F., no more than 10° F., or no more than 5° F. greater than the average temperature of the material, and/or such that no portion of the material is heated to a temperature less than 25° F., less than 20° F., less than 15° F., less than 10° F., or less than 5° F. below the average temperature of the material. In some cases, cooling may be applied to the material during heating, e.g., to ensure that the heat is applied in a relatively uniform manner. For example, the air around the material may be circulated or convected to ensure relatively uniform heating.

In addition, in some embodiments, pressure may be applied to the material, instead of or in addition to heating. In some cases, heating and pressing can occur simultaneously, or at least partially overlap in time. In other cases, heating and pressing occur sequentially. Any suitable technique may be used to apply pressure to the material, including applying the pressure pneumatically, mechanically, hydraulically, placing the material in a high-pressure gas chamber, applying pressure using a rotary press, applying pressure using a platen press, or the like. In addition, in some cases, the pressure may be at least partially internally generated.

In some embodiments, the material comprises a foam. Any suitable foam can be used, including open-cell foams and closed-cell foams (for example, modified to permeabilize the cells), as well as combinations thereof. If the article comprises a plurality of closed cells, the cells may have substantially the same or substantially different volumes, shapes, or dimensions. The foam may also have any average cell size, which can be readily determined using techniques known to those of ordinary skill in the art, e.g., such as microscopic techniques. For example, the foam can have a number average cell size (with cell size being the smallest cross-sectional dimension of the cell) determined by microscopy or a mean flow pore size determined by porometry of less than about 1 cm, less than about 5 mm, less than about 3 mm, less than about 1 mm, less than about 0.5 mm, less than about 0.3 mm, or less than about 0.2 mm. The average cell size may also be less than about 100 micrometers, less than about 90 micrometers, less than about 80 micrometers, less than about 70 micrometers, less than about 60 micrometers, less than about 50 micrometers, less than about 40 micrometers, less than about 30 micrometers, less than about 20 micrometers, less than about 10 micrometers, etc. The foam may also, in certain instances, have an average cell size of at least about 10 micrometers, at least about 20 micrometers, at least about 30 micrometers, at least about 40 micrometers, at least about 50 micrometers, at least about 60 micrometers, at least about 70 micrometers, at least about 80 micrometers, at least about 90 micrometers, at least about 100 micrometers, at least about 200 micrometers, at least about 300 micrometers, at least about 500 micrometers, at least about 1 mm, at least about 3 mm, at least about 5 mm, at least about 1 cm, etc. The foam can also have an average cell size that falls between any two of the above stated ranges, e.g., the foam may have an average cell size of between about 1 mm and about 5 mm. Techniques known to those of ordinary skill in the art, such as microscopy or electron microscopy, capillary flow porometry, etc. may be used to determine the average cell size.

The foam may be substantially flame resistant and/or the foam may be acoustic insulating, e.g., due to the presence of cells within the foam, in some cases. For example, the foam can have relatively low permeability to gases such as air or other types of gases. The foam can also provide structural support in certain embodiments. For instance, the foam may provide rigidity or structural stability to the material. The foam may also be self-supporting or load-bearing. However, in other cases, the foam is flexible or readily deformable. Non-limiting examples of foams that can be used include, but are not limited to, polymeric foams such as Styrofoam, polyurethane foams, polyvinylidene fluoride foams, polyimide foams, latex foams, polyetherimide foams, melamine foams, or the like. The foam may comprise only one of these polymers, or in some instances, the foam comprises more than one of these polymers. The foam can also be a syntactic foam in certain cases, and/or the foam may comprise other materials, such as cenospheres, glass microspheres, carbon microspheres, polymeric microspheres, etc. The microspheres, if present, can be solid or hollow. The foam may be attached to a nonwoven and/or a woven material, in accordance with various embodiments.

In certain embodiments, pressure may be applied to bond an agent, such as polyeythene oxide, to the material. In some cases, heat may also be applied, e.g., simultaneously and/or sequentially with the application of pressure, in any suitable order. For example, the pressure may be applied pneumatically, mechanically, hydraulically, and/or placing the material in a high-pressure gas chamber. In addition, in some cases, the pressure may be at least partially internally generated.

The pressure may be applied to substantially all or only a portion of the material, depending on the application. In one set of embodiments, the applied pressure may be at least 5 psi (gauge pressure), at least 10 psi, at least 20 psi, at least 30 psi, at least 40 psi, at least 50 psi, at least 60 psi, at least 70 psi, at least 80 psi, at least 90 psi, at least 100 psi, at least 110 psi, at least 120 psi, at least 130 psi, at least 140 psi, at least 150 psi, at least 160 psi, at least 170 psi, at least 180 psi, at least 190 psi, at least 200 psi, at least 250 psi, at least 300 psi, at least 350 psi, at least 400 psi, at least 450 psi, at least 500 psi, etc. (1 psi is 6894.757 Pa.) The pressure may also be, in some embodiments, no more than 500 psi, no more than 450 psi, no more than 400 psi, no more than 350 psi, no more than 300 psi, no more than 250 psi, no more than 200 psi, no more than 190 psi, no more than 180 psi, no more than 170 psi, no more than 160 psi, no more than 150 psi, no more than 140 psi, no more than 130 psi, no more than 120 psi, no more than 110 psi, no more than 105 psi, no more than 100, psi, no more than 90 psi, no more than 80 psi, no more than 70 psi, no more than 60 psi, no more than 50 psi, no more than 40 psi, no more than 30 psi, no more than 20 psi, no more than 10 psi, no more than 5 psi, etc. In addition, the pressure can be contained within any of these values, e.g., a pressure of between 100 psi and 120 psi, between 20 psi and 120 psi, between 20 psi and 80 psi, between 40 psi and 60 psi, etc. Furthermore, in some embodiments, different portions of the material may be subjected to different pressures, e.g., any of the pressures described above.

Such heat and/or pressures may be applied for any suitable time. The heat and/or pressure may be steadily applied, or in some cases, the heat and/or pressure may vary with respect to time. If both heat and pressure are used, the times each are applied may be the same or different, and one or more can be, for example, less than about 1 minute, less than about 45 seconds, less than about 30 seconds, less than about 20 seconds, less than 15 seconds, less than 10 seconds, or less than 5 seconds. Other non-limiting of times one or more of heat and pressure can independent be applied include about 1 minute or more, about 2 minutes or more, about 3 minutes or more, about 4 minutes or more, about 5 minutes or more, about 6 minutes or more, about 7 minutes or more, about 8 minutes or more, about 9 minutes or more, about 10 minutes or more, about 12 minutes or more, about 15 minutes or more, about 20 minutes or more, about 25 minutes or more, about 30 minutes or more, about 35 minutes or more, about 40 minutes or more, about 45 minutes or more, about 50 minutes or more, about 55 minutes or more, about 60 minutes or more, etc.

In some cases, heat and/or pressure can be applied in a continuous fashion, e.g., to a material, such as a nonwoven and/or a woven material. For instance, a roll of material may be unwound and linearly passed through a press and/or a heater, and heat and/or pressure applied as the material passes through.

In some embodiments, other processes can also be applied to a material, e.g., to increase its rigidity or structural stability, in addition or instead of heating and/or pressure. Examples include, but are not limited to, electromagnetic energy (e.g., thermal, ultraviolet radiation, etc.), acoustical energy (e.g., ultrasonic energy), chemical enhancement (e.g., salting with other crystal structures, resins, etc.), and/or physical manipulation (e.g., elongation, compaction, stretching, etc.). One or more of these processes may be applied to the material before, during, or after the material is formed. In some cases, these may be applied serially or simultaneously, etc.

For example, in one set of embodiments, ultrasound is applied to the material. The ultrasound may have any suitable frequency, e.g., at least about 15 kHz, at least about 20 kHz, at least about 25 kHz, at least about 30 kHz, at least about 35 kHz, at least about 40 kHz, at least about 45 kHz, at least about 50 kHz, or the like, and may be applied using any suitable technique, e.g., an ultrasonic transducer such as those commercially available. In some cases, the frequency is no more than about 60 kHz, no more than about 50 kHz, no more than about 45 kHz, no more than about 40 kHz, no more than about 35 kHz, no more than about 30 kHz, no more than about 25 kHz, no more than about 20 kHz, etc. In addition, the power may be at least about 50 W, at least about 75 W, at least about 100 W, at least about 150 W, at least about 200 W, etc. The ultrasound can also be applied for any length of time, e.g., for about 5 minutes or more, about 10 minutes or more, about 12 minutes or more, about 15 minutes or more, about 20 minutes or more, about 25 minutes or more, about 30 minutes or more, about 35 minutes or more, about 40 minutes or more, about 45 minutes or more, about 50 minutes or more, about 55 minutes or more, about 60 minutes or more, etc.

As another example, in some cases, a resin may be added to the material to increase its rigidity. Examples of resins that can be used include, but are not limited to, phenolic resins, acetal resin, acrylic resins, polyetheretherketone resins, polyester resins such as unsaturated polyester resins, polyphenelene sulfide resins, polyetherimide resin, melamine resins, epoxy resins, silica resins, urethane resins, solvent impregnated resins, polyvinyl alcohol resins, or the like. In addition, in some embodiments, the material can also contain compounds that are able to alter its permeability, for example, certain inorganic compounds .

In one set of embodiments, the material may be treated to reduce heat transfer through the material, and/or to inhibit or resist the spread of fire through the material. For example, any of a variety of flame retardants can be used to treat the material, and the flame retardants can be added before and/or after the material is formed. The flame retardant, for instance, may be applied to the fibers before they are assembled to form the material, or the material, after formation, can be exposed to flame retardant by any suitable technique. In some embodiments, the flame retardant may be sprayed onto the material, the material may be dipped or immersed in flame retardant (e.g., contained within a suitable container), the flame retardant may be painted onto the material, the flame retardant may be electrostatically bonded to the material, or the like. The fibers, in some cases, can become partially or fully impregnated with the flame retardant, and/or the flame retardant may form a shell or coating around one or more of the fibers within the material. In some instances, the fibers are saturated in flame retardant.

Examples of flame retardants include, but are not limited to, minerals such as aluminum hydroxide, aluminum oxide, aluminum trihydrate, magnesium carbonate hydroxide, magnesium hydroxide, huntite, hydromagnesite, hydrates, red phosphorus, boron compounds such as zinc borate or sodium borate, zinc carbonate, antimony trioxide, antimony pentoxide, sodium antimonate, sodium carbonate, antimony carbonate, aluminum carbonate, etc.; organochlorines such as chlorendic acid derivatives and chlorinated paraffins; organobromines such as polybrominated diphenylethers, decabromodiphenyl ether, decabromodiphenyl ethane, hexabromobutene, dibromoethyl dibromocyclohexane, hexabromocyclododecane, diboromoneopentyl glycol, tribromoneopentyl alcohol, brominated aliphatic polyol, polyethertriol, octabromodiphenyl ether, pentabromodiphenyl ether, fully brominated diphenoxy benzene, decabromodiphenyl ether, octabromodiphenylether, pentabromodiphenylether, (bis-pentabromophenyl)ethane, brominated trimethylphenylindan, tetrabromobisphenol A, bis(tribromophenoxy)ethane, polydibromophenylene oxide, tetrabromophthalic anhydride, 1,2-bis(tetrabromophthalimide)ethane, tetrabromophthalate diols, tetrabromophthalate esters, tetrabromobisphenol A, polydibromophenylene oxide, brominated polystyrene, poly(pentabromobenzyl)acrylate, polymeric brominated compounds such as brominated polystyrenes, brominated carbonate oligomers, brominated epoxy oligomers, tetrabromophthalic anyhydride, tetrabromobisphenol A, hexabromocyclododecane, etc.; sulfamic acid or sulfamates; sulfamides; or organophosphorous or organophosphate compounds such as tris(2,3-dibromopropyl) phosphate, triphenyl phosphate, trisdichloropropyl phosphate, cresyldiphenyl phosphate, resorcinol bis(diphenylphosphate), bisphenol A bis(diphenyl phosphate), melamine phosphate, tri-o-cresyl phosphate, dimethyl methylphosphonate, phosphinates, tri-m-cresyl phosphate, tris(2-chloropropyl) phosphate, tris-(1.3-dichloro-2-propyl) phosphate, tris(chloroethyl) phosphate, trisdichloropropylphosphate, tri-p-cresyl phosphate, trischloropropylphosphate, tris(chloroisopropyl)phosphate, tri(isopropylphenyl)phosphate, tetrakis(2-chloroethyl) dichloroisopentyldiphosphate, dimethyl methyl phosphonate, 9,10-dihydro-9-oxa-10-phosphaphenanthrene-10-oxide, 6-(2,5-dihydroxyphenyl)-6H-dibenz[c,e][1,2]oxaphosphorine-6-oxide, tetraphenyl resorcinol bis(diphenylphosphate), etc. In addition, combinations of any of these and/or other flame retardants can also be used in other embodiments. For example, the flame retardant that is applied may comprise one, two, three, or more of any of these, and/or other flame retardants.

In another set of embodiments, the material may be treated with an antimicrobial agent. Any of a wide variety of antimicrobial agents may be used, including antibacterials, antifungals, antiseptics, or the like. The antimicrobial agents can be added to the material before and/or after the material is formed, or the material, after formation, may be exposed to antimicrobials by any suitable technique, such as spraying or dipping, etc.

Examples of antimicrobial agents include, but are not limited to, organic acids such as lactic acid, citric acid, acetic acid, and their salts; metals such as copper or silver (e.g., which may be impregnated within polymers such as those contained within the composite); Silpure (which also contains silver), or Ultra-Fresh DM-25 or Ultra-Fresh DW-56 (Thompson Research); or oils such as cinnamon oil, clove oil, eucalyptus oil, garlic oil, oregano oil, lavender oil, leleshwa oil, lemon oil, lemon myrtle oil, mint oil, neem oil, black cumin oil, onion oil, peppermint oil, sandalwood oil, ironwort, tea tree oil, or thyme oil. Examples of antibacterials and antiseptics include, but are not limited to, alcohols; quaternary ammonium compounds such as benzalkonium chloride, cetyl trimethylammonium bromide, cetylpyridinium chloride, benzethonium chloride, chlorhexidine, octenidine; boric acid; aldehydes such as formaldehyde and glutaraldehyde; or phenolics such as phenol, o-phenylphenol, chloroxylenol, hexachlorophene, thymol, or the like. Non-limiting examples of antifungals include tea tree oil, cinnamaldehyde, cinnamon essential oil, jojoba oil, neem oil, rosemary oil, monocerin, or the like.

In some aspects, one or more additional materials may be attached or immobilized to the material, and/or otherwise be present in the final composite. The one or more materials may be attached or immobilized by any suitable technique, e.g., via adhesion, needling, quilting, stichbonding, needlepunching or needlefelting, thermal bonding, hydroentaglement, ultrasonic bonding, chemical bonding, lamination, heating, pressing, or the like. As mentioned, the materials may include nonwoven and/or woven portions, in various embodiments.

The following examples are intended to illustrate certain embodiments of the present disclosure, but do not exemplify the full scope of the disclosure.

U.S. Provisional Pat. Application Serial No. 63/003,825, filed Apr. 1, 2020, entitled “Materials, Including Nonwoven Materials, and Methods Thereof,” by D’Elia, et al., is incorporated herein by reference in its entirety.

### Example 1

This example illustrates a test for determining uniformity of bonding, in accordance with certain embodiments. This example illustrates how the degree or uniformity of bonding of agents such as polymers added to the material may be determined or tested. For instance, the consistency of the application of the agents in terms of amount or distribution can be determined.

An example test method of determining the distribution of an agent (for example, polyethylene oxide) is described here. This method can be used to determine the distribution or degree of bonding of the agent to the material and/or to itself. In some cases, the consistency of the application of the agent in terms of amount or distribution may be determined.

One example of this test involves an apparatus that is essentially a cylinder divided into two halves cut along the plane defined by the diameter of the cylinder. A sample of the material is sandwiched between the two cylinders in such a manner that there is a seal between the two halves of the cylinder. The thickness of the material is approximately 0.1 inches thick per ply (layer) of material. The integrity of this seal may be greater than the pressures applied to the interior of the cylinder in the course of the test.

The cylinder is mounted such that the height of the cylinder is vertical, and the material is held in the horizontal plane. A fluid is introduced into the upper cylinder where it will rest on the surface of the material. An example of the amount of fluid would be a minimum of 300% of the volume of material exposed to the fluid, although in other cases, the fluid may be more or less than this, for example a minimum of 100%, 200%, 400% or 500% of the volume of the material being tested within the cylinder.

In one test, the movement of a non-reactionary fluid with respect to the agents (for example, polyethylene oxide) through the material is determined. Examples of non-reactionary fluids (e.g., with respect to an agent, such as polyethylene oxide) include, but are not limited to, kerosene, or other materials described herein. The volume of the fluid may be at least 300% of the volume of material being tested within the cylinder, or other volumes such as those described herein. In one non-binding example, the lower half of the cylinder may be pressurized, pushing air though the material into the vented upper half of the cylinder, where it bubbles through the fluid and escapes into atmosphere. For example, the pressure may be increased to at least 1 psi (gauge), at least 2 psi, at least 5 psi, at least 10 psi, at least 15 psi, at least 20 psi, at least 25 psi, at least 30 psi, at least 40 psi, at least 50 psi, at least 60 psi, at least 75 psi, at least 100 psi, etc. (1 psi = 6894.76 Pa).

In another non-binding example, a non-reactionary fluid is added to the top portion of the cylinder to rest on the surface of the material, e.g., to the volumes described in this example. The top portion of the cylinder is sealed and the bottom portion of the cylinder is vented. The top portion of the cylinder may be pressurized, e.g., to the pressures described herein, pushing the non-reactionary fluid through the material into the vented lower cylinder. In some cases, the magnitude and/or duration of pressure needed to force the fluid through the material can be used to define the effectiveness and the consistency of the material with respect to the test fluid. For example, materials with more uniformly bonded agent may show increased pressure magnitudes or durations before breakthrough occurs and the fluid begins passing through the material.

In another test, the functionality of the agents added to the material may be determined. A reactionary fluid that is known to interact with the agent (for example, polyethylene oxide) is introduced into the upper half of the cylinder, where it rests on the surface of the material. Examples of reactionary fluids (e.g., with respect to an agent such as polyethylene oxide) include, but are not limited to, water. The volume of the fluid may be at least 300% of the volume of material being tested within the cylinder, or other volumes such as those described herein. The upper half of the cylinder is pressurized, and the lower half is vented, pushing the test fluid into the material. The magnitude and/or duration of pressure needed to force the test fluid through the material may then be used to define the effectiveness and the consistency of the material with respect to the test fluid.

These tests should account for other forces. For example, pressurizing the reactionary fluid on top of the material imparts a physical force on the material that can distend or burst the material, for example, in a manner similar to that of a standard Mullen Burst or Ball Burst tests for textiles, reference test methodologies ASTM D774 and ASTM D3786. This physical distortion of the material can directly influence the results of the test. Accordingly, a large-gauge screen (e.g., 20 mesh stainless steel) is put under the material to support it to prevent it from distending or distorting under the pressure differential; the mesh of the screen is large enough that it does not significantly impede fluid movement through the material.

### Example 2

This example provides an example of using the system of Example 1 to evaluate the functionality and distribution of an agent bonded to a material. The material was prepared based on the example described above using a material comprising PET and Tencel fibers with polyethylene oxide applied and bonded to the materials. The polyethylene oxide complexes water and does not complex hydrocarbon-based fluids. A 2.5-inch x 2.5-inch specimen was mounted on an apparatus comprising an acrylic cylinder with an inner diameter of 1.5 inches. Paraffin lamp oil is introduced into the upper portion of the cylinder where it rested on the surface of the material. The upper portion of the cylinder was then sealed, and the lower portion of the cylinder was vented.

Next compressed air is introduced into the upper cylinder to a maximum of 2 psi (13,789.5 Pa). The lamp oil flowed through the material.

The upper cylinder was then depressurized and water introduced into the upper half of the cylinder where it rested on the surface of the material. The upper portion of the cylinder was then sealed, and the lower portion of the cylinder was vented. Compressed air is introduced into the upper cylinder to a minimum of 30 psi (206.843 Pa). No water should penetrate the material and enter the lower half of the cylinder for a minimum of five minutes.

In some cases, a small amount of food-grade dye can be introduced into the water to differentiate it from any lamp oil.

The acceptance criteria for the test may, in some cases, depend on the design of material, and the agent bonded to the material.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An article, comprising:
a nonwoven material comprising fibers and polyethylene oxide bonded to at least some of the fibers and to itself, the polyethylene oxide having an average molecular weight (Mᵥ) of between 5,000,000 and 12,000,000,
wherein the nonwoven material comprising the fibers and the polyethylene oxide has an air permeability of at least 5 ft³/min/ft² at a pressure differential of 0.5 inches of water and 77° F.

2. The article of claim 1, wherein the fibers comprise thermoplastic fibers.

3. The article of any one of claims 1 or 2, wherein the fibers comprise polyester fibers.

4. The article of any one of claims 1-3, wherein the fibers comprise polyethylene terephthalate (PET) fibers.

5. The article of any one of claims 1-4, wherein the fibers comprise rayon fibers.

6. The article of any one of claims 1-5, wherein the fibers comprise lyocell fibers.

7. The article of any one of claims 1-6, wherein the fibers comprise acetate fibers.

8. The article of any one of claims 1-7, wherein the fibers comprise polyvinyl acetate fibers.

9. The article of any one of claims 1-8, wherein at least some of the fibers consists essentially of a single polymer.

10. The article of any one of claims 1-9, wherein at least some of the fibers are spunbonded.

11. The article of any one of claims 1-10, wherein at least some of the fibers are point bonded.

12. The article of any one of claims 1-11, wherein the nonwoven material has a weight of at least 0.4 oz/yd².

13. The article of claim 12, wherein the nonwoven material has a thickness of between 0.01 inches and 0.1 inches.

14. The article of any one of claims 1-13, wherein the nonwoven material in the absence of polyethylene oxide has a weight of between 0.4 oz/yd² and 3.0 oz/yd².

15. The article of claim 14, wherein the nonwoven material has a thickness of between 0.01 inches and 0.1 inches.

16. The article of any one of claims 1-15, wherein the nonwoven material has an air permeability of at least 50 ft³/min/ft² at a pressure differential of 0.5 inches of water and 77° F.

17. The article of any one of claims 1-16, wherein the nonwoven material has an air permeability of at least 10 ft³/min/ft² at a pressure differential of 0.5 inches of water and 77° F.

18. The article of any one of claims 1-17, wherein the nonwoven material has an air permeability of at least 20 ft³/min/ft² at a pressure differential of 0.5 inches of water and 77° F.

19. The article of any one of claims 1-18, wherein the nonwoven material has an air permeability of at least 50 ft³/min/ft² at a pressure differential of 0.5 inches of water and 77° F.

20. The article of any one of claims 1-19, wherein the polyethylene oxide has an average molecular weight of between 5,000,000 and 7,000,000.

21. The article of any one of claims 1-19, wherein the polyethylene oxide has an average molecular weight of between 7,000,000 and 9,000,000.

22. The article of any one of claims 1-19, wherein the polyethylene oxide has an average molecular weight of between 9,000,000 and 11,000,000.

23. The article of any one of claims 1-22, wherein the polyethylene oxide is chemically bonded to the nonwoven material.

24. The article of any one of claims 1-23, wherein the polyethylene oxide is physically bonded to the nonwoven material.

25. The article of any one of claims 1-24, wherein the polyethylene oxide is bonded to the nonwoven material as a thermoplastic.

26. The article of any one of claims 1-25, wherein the polyethylene oxide is bonded to the nonwoven material as a resin.

27. The article of any one of claims 1-26, wherein the polyethylene oxide is bonded to at least 50% of the fibers.

28. The article of any one of claims 1-27, wherein the polyethylene oxide is bonded to at least 80% of the fibers.

29. The article of any one of claims 1-28, wherein the polyethylene oxide is bonded to at least 90% of the fibers.

30. The article of any one of claims 1-29, wherein the polyethylene oxide is bonded to substantially all of the fibers.

31. The article of any one of claims 1-30, wherein the nonwoven material, in the absence of the polyethylene oxide, has an air permeability of at least 50 ft³/min/ft² at a pressure differential of 0.5 inches of water and 77° F.

32. The article of any one of claims 1-31, wherein the polyethylene oxide is substantially uniformly bonded to the nonwoven material.

33. The article of claim 32, wherein the polyethylene oxide is substantially uniformly bonded to the nonwoven material such that the article passes a test wherein a sample of the nonwoven material is exposed to water and a pressure of 120 psi such that the water is unable to flow through the nonwoven material for at least 5 minutes.

34. The article of claim 33, wherein article is prevented from being distended during the test.

35. A method, comprising:
exposing a nonwoven material comprising fibers to polyethylene oxide; and
bonding the polyethylene oxide to the nonwoven material and to itself, wherein the polyethylene oxide has an average molecular weight (Mᵥ) of between 5,000,000 and 12,000,000.

36. The method of claim 35, wherein bonding the polyethylene oxide comprises bonding the polyethylene oxide to the nonwoven material such that the polyethylene oxide is substantially uniformly bonded to the nonwoven material.

37. The method of claim 36, wherein the polyethylene oxide is substantially uniformly bonded to the nonwoven material such that the article passes a test wherein a sample of the nonwoven material is exposed to water and a pressure of 120 psi such that the water is unable to flow through the nonwoven material for at least 5 minutes.

38. The method of claim 37, wherein article is prevented from being distended during the test.

39. The method of any one of claims 35-38 wherein the nonwoven material comprises thermoplastic fibers.

40. The method of any one of claims 35-39, comprising exposing the nonwoven material to a surface treatment between 20 g/yd² and 200 g/yd² of polyethylene oxide.

41. The method of any one of claims 35-40, comprising exposing the nonwoven material to a surface treatment of between 70 g/yd² and 160 g/yd² of polyethylene oxide.

42. The method of any one of claims 35-41, comprising exposing the nonwoven material to a surface treatment of between 40 g/yd² and 90 g/yd² of polyethylene oxide.

43. The method of any one of claims 35-42, comprising exposing the nonwoven material to a surface treatment of between 40 g/yd² and 70 g/yd² of polyethylene oxide.

44. The method of any one of claims 35-43, wherein the fibers comprise polyethylene terephthalate (PET).

45. The method of any one of claims 35-44, wherein the fibers comprise acetate.

46. The method of any one of claims 35-45, wherein the nonwoven material in the absence of polyethylene oxide has a weight between 0.4 oz/yd² and 3.0 oz/yd².

47. The method of claim 46, wherein the nonwoven material has a thickness of between 0.01 inches and 0.1 inches.

48. The method of any one of claims 35-47, wherein bonding the polyethylene oxide comprises scatter-coating the polyethylene oxide to the nonwoven material.

49. The method of any one of claims 35-48, wherein bonding the polyethylene oxide comprises sintering the polyethylene oxide to the nonwoven material.

50. The method of any one of claims 35-49, wherein bonding the polyethylene oxide comprises applying heat to the nonwoven material.

51. The method of claim 50, comprising heating the nonwoven material to at least 180° F.

52. The method of any one of claims 50 or 51, comprising heating the nonwoven material to between 180° F. and 340° F.

53. The method of any one of claims 35-52, wherein bonding the polyethylene oxide comprises applying conductive heat to the nonwoven material.

54. The method of any one of claims 35-53, wherein bonding the polyethylene oxide comprises applying convective heat to the nonwoven material.

55. The method of any one of claims 35-54, wherein bonding the polyethylene oxide comprises applying pressure to the nonwoven material.

56. The method of claim 55, comprising applying a pressure of at least 20 psi.

57. The method of any one of claims 55 or 56, comprising applying between 20 psi and 120 psi of pressure.

58. The method of any one of claims 55-57, comprising applying between 20 psi and 80 psi of pressure.

59. The method of any one of claims 55-58, comprising applying pressure using a rotary press.

60. The method of any one of claims 55-59, comprising applying pressure using a platen press.

61. An article, comprising:
a nonwoven material comprising fibers and polyethylene oxide bonded to at least some of the fibers and to itself, the polyethylene oxide having an average molecular weight (Mᵥ) of between 5,000,000 and 12,000,000,
wherein the nonwoven material comprising the fibers and the polyethylene oxide has an air permeability of at least 15 m³/(min m²) at a pressure differential of 124 Pa and 25° C.

62. An article, comprising:
a material comprising fibers and polyethylene oxide bonded to at least some of the fibers and to itself, the polyethylene oxide having an average molecular weight (Mᵥ) of between 5,000,000 and 12,000,000,
wherein the material comprising the fibers and the polyethylene oxide has an air permeability of at least 5 ft³/min/ft² at a pressure differential of 0.5 inches of water and 77° F.

63. A method, comprising:
exposing a material comprising fibers to polyethylene oxide; and
bonding the polyethylene oxide to the material and to itself, wherein the polyethylene oxide has an average molecular weight (Mᵥ) of between 5,000,000 and 12,000,000.

64. An article, comprising:
a material comprising fibers and polyethylene oxide bonded to at least some of the fibers and to itself, the polyethylene oxide having an average molecular weight (Mᵥ) of between 5,000,000 and 12,000,000,
wherein the material comprising the fibers and the polyethylene oxide has an air permeability of at least 15 m³/(min m²) at a pressure differential of 124 Pa and 25° C.

65. An article, comprising:
a material comprising fibers and polyethylene oxide bonded to at least some of the fibers and to itself, the polyethylene oxide having an average molecular weight (Mᵥ) of between 5,000,000 and 12,000,000, wherein the material is water-repellent as determined using ASTM D2842.
